(19) United States
(12) Patent Application Publication
(10) Pub. No.: US 2010/0041344 A1
(43) Pub. Date: Feb. 18, 2010

(54) Method for transmitting channel quality indicators

(76) Inventors: Bong Hoe Kim, Anyang-si (KR); Dae Won Lee, Anyang-si (KR); Yu Jin Noh, Anyang-si (KR); Dong Wook Roh, Anyang-si (KR)

Correspondence Address: MCKENNA LONG & ALDRIDGE LLP, 1900 K STREET, NW, WASHINGTON, DC, 20006, US

(21) Appl. No.: 12/461,253

(22) Filed: Aug. 5, 2009

Related U.S. Application Data
(60) Provisional application No. 61/088,707, filed on Aug. 13, 2008.

(30) Foreign Application Priority Data
Oct. 14, 2008 (KR) 10-2008-0104649

(51) Int. Cl. H04B 7/005

(52) U.S. Cl. 455/69

(57) ABSTRACT

A method for transmitting Channel Quality Indicators (CQIs) of all carrier bands in a system using a plurality of carrier bands (legacy system bands) is disclosed. In order to provide sufficient information to a scheduler, the CQIs of all the carrier bands are generated and transmitted by the same method or a predetermined number of carrier bands are selected and only the CQIs of the selected carrier bands are transmitted. Thus, it is possible to efficiently control signal resources. By simply expanding the method for transmitting the CQIs of the carrier bands, it is possible to facilitate the expansion of the system.

### CROSS REFERENCE TO RELATED APPLICATIONS

This application claims the benefit of U.S. provisional application No. 61/088,707 filed on Aug. 13, 2008 which is hereby incorporated by reference as if fully set forth herein.

This application claims the benefit of Korean Patent Application No. 10-2008-0104649, filed on Oct. 14, 2008 which is hereby incorporated by reference as if fully set forth herein.

### BACKGROUND OF THE INVENTION

1. Field of the Invention

The present invention relates to a method for transmitting Channel Quality Indicators (CQIs) in a mobile communication system, and more particularly, to a method for efficiently generating and transmitting CQIs by a User Equipment (UE) in a communication system using a plurality of legacy system bands.

2. Discussion of the Related Art

For efficient communication, it is necessary for a receiver to feed back channel information to a transmitter. In general, downlink channel information is transmitted in uplink and uplink channel information is transmitted in downlink. Such channel information is referred to as a Channel Quality Indicator (CQI). Such a CQI may be generated by various methods.

For example, a method for quantizing a channel status and transmitting the quantized channel status, a method for calculating and transmitting a Signal to Interference and Noise Ratio (SINR), and a method for reporting a status, in which a channel is actually applied, such as a Modulation Coding Scheme (MCS), may be used.

Among the various methods for generating a CQI, a method for generating a CQI based on an MCS is mainly used. Thus, this method will be described in detail. For example, there is a method for generating a CQI for a transmission scheme such as a High Speed Downlink Packet Access (HSDPA) in the 3rd Generation Partnership Project (3GPP). If a CQI is generated based on an MCS, the MCS includes a modulation scheme, a coding scheme, a coding rate and the like. Accordingly, if the modulation scheme and the coding scheme are changed, the CQI is also changed. Thus, at least one CQI is necessary per codeword.

If a Multiple Input Multiple Output (MIMO) scheme is applied to a system, the number of necessary CQIs is also changed. That is, since a MIMO system generates multiple channels using multiple antennas, a plurality of codewords is generally available. Accordingly, a plurality of CQIs should be used. If the plurality of CQIs is used, the amount of control information is proportionally increased.

FIG. 1 is a conceptual diagram of the generation and transmission of CQIs.

A User Equipment (UE) measures downlink quality and reports a CQI value selected based on the downlink quality to a base station through an uplink control channel. The base station performs downlink scheduling (UE selection, resource assignment and the like) according to the reported CQI. The CQI value includes an SINR, a Carrier to Interference and Noise Ratio (CINR), a Bit Error Rate (BER) and a Frame Error Rate (FER) of a channel, a value obtained by converting these values into transmittable data, and the like. In addition, in the MIMO system, the CQI may further include Rank Information (RI), Precoding Matrix Information (PMI) and the like, as information indicating the channel status.

In a mobile communication system, in order to make the maximum use of the capacity of a given channel, an MCS and transmission power are adjusted according to the given channel using link adaptation. In order to perform such link adaptation in a base station, a user should feed back channel quality information to the base station.

If a frequency band used by the system exceeds a coherence bandwidth, the channel is rapidly changed within the used bandwidth. In particular, in a multicarrier system such as an Orthogonal Frequency Division Multiplexing (OFDM) system, since several subcarriers are present within a given bandwidth and modulated symbols are respectively transmitted through the subcarriers, channel information should be transmitted through every subcarrier, for optimal channel transmission. Accordingly, in the multicarrier system in which the number of subcarriers is plural, the feedback amount of channel information is rapidly increased. Therefore, various methods for reducing control overhead have been suggested.

Meanwhile, the transmission number of CQIs is increased in various dimensions and thus overhead may be increased.

First, the increase of the number of CQIs in a spatial dimension will be described. If several codewords are transmitted through several layers in the MIMO scheme, several CQIs are necessary. For example, in a 3GPP LTE system, a maximum of two codewords is available in the MIMO scheme. At this time, two CQIs are necessary. If the CQI of one codeword is composed of N bits and the number of codewords is two, the CQIs should be composed of a total of 2*N bits. Since the CQIs are transmitted to all users who need to know the channel status, the CQIs occupy a large portion of all radio resources. Accordingly, the number of CQIs is preferable reduced in terms of channel capacity.

Second, the increase of the number of CQIs in a frequency dimension will be described. The above CQIs are transmitted in one frequency band. If a receiver selects a frequency band with the best channel status and transmits CQIs only in the selected frequency and a transmitter performs a service through the selected frequency band of the CQIs, the CQIs are transmitted only in one band. This is suitable for a single user environment, but is not suitable for a multi-user environment. Accordingly, a more efficient method is necessary. Next, a problem which may occur in a scheduling process when the CQIs are transmitted in only one preferred band will be described in detail. No problem occurs if the preferred frequency bands of multiple users are different so as not to overlap with one another, but a problem may occur if several users simultaneously select a specific frequency band as a best channel environment. In this case, the users other than a selected user cannot use the frequency band. If the users transmit the CQIs in only one preferred frequency band, the unselected users lose an opportunity to receive a service. Accordingly, in order to solve such a problem and efficiently obtain a multi-user diversity gain, the transmission of CQIs in several frequency bands is necessary. If CQIs are transmitted in several frequency bands, the transmission information amount of CQIs is increased by the number of selected frequency bands. For example, if three frequency bands with best channel statuses are selected and CQIs and frequency band indicators are transmitted, the transmission amount of CQIs is tripled. Additional transmission for an indicator indicating the selected frequency bands is necessary.

Third, the increase of the number of CQIs in both the spatial and frequency dimensions may be considered. That is, the case where several CQIs are necessary in the spatial dimension and several CQIs are necessary in the frequency dimension may be considered.

Fourth, the increase in the number of CQIs in the other dimensions may be considered. For example, if a Code Division Multiple Access (CDMA) scheme is used, a variation in signal strength, interference amount and the like occurs according spreading codes and thus the increase of the number of CQIs according to the spreading codes may be considered. Accordingly, the increase of the number of CQIs in a code dimension may be considered. The increase in the number of CQIs in other dimensions may be considered.

The case where several CQIs are necessary in various dimensions has been described up to now. If several CQIs are necessary, in order to reduce the transmission amount of CQIs, a delta CQI is available. That is, one reference CQI is selected and is normally transmitted. However, with respect to the other CQIs, only differences between the other CQIs and the reference CQI are transmitted. That is, a method similar to a differential modulation method of a modulation/demodulation scheme is used. If several CQIs are represented by the differential method, a large number of bits is generally assigned to a CQI reference value and a relatively small number of bits is assigned to a differential value, thereby reducing the transmission amount of CQIs.

Meanwhile, in a next-generation mobile communication system, in order to efficiently use multiple bands or multiple carriers, technology for managing several carriers (several Frequency Assignments (FAs)) by one entity corresponding to a specific layer of a physical layer or higher has been suggested.

FIGS. 2(a) and 2(b) are conceptual diagrams explaining the multiband RF-based signal transmission and reception methods of a transmitter and a receiver.

In FIGS. 2(a) and 2(b), PHY0, PHY1, . . . , PHYn−2 and PHYn−1 denote the multiple bands according to the present technology and each of the bands may have the size of an FA assigned for a specific service according to a predetermined frequency policy. For example, PHY0 (RF carrier 0) may have the size of a frequency band assigned for a general FM radio broadcast and PHY1 (RF carrier 1) may have the size of a frequency band assigned for mobile telephone communication. In the following description, in order to guarantee a wider system bandwidth in a next-generation mobile communication system such a 3GPP LTE-4 system, the case where several system bands of 20 MHz assigned for the existing system, that is, the 3GPP LTE system, are combined and used will be described. The frequency bands may have different frequency band sizes according to the respective frequency band characteristics. However, in the following description, for convenience of description, it is assumed that the FAs have a constant size. The above-described FAs may be referred to as “legacy system bands”, in order to avoid confusion with the concept of “multicarriers”, which is widely used in a system using a plurality of subcarriers, such as the existing OFDM based communication system, and to use a plurality of system bands in the existing system (legacy system). The legacy system bands are representative of carrier frequencies for using a baseband signal in frequency bands. Hereinafter, the FAs are referred to as “carrier frequency bands” or “carriers” if such use will not lead to confusion.

In order to transmit a signal through multiple bands as shown in FIG. 2(a) and receive a signal through multiple bands as shown in FIG. 2(b), both a transmitter and receiver need to include an RF module to transmit or receive the signal through multiple bands. In FIG. 2, a method for configuring “MAC” is determined by a base station regardless of downlink and uplink.

In brief, the present technology refers to a technology in which a predetermined number of specific-layer entities, that is, one MAC entity in the example of FIG. 2 (hereinafter, referred to as “MAC” if such use will not lead to confusion), manages or operates a plurality of RF carriers so as to transmit or receive a signal. In addition, the RF carriers managed by the specific entity do not need to be contiguous to each other. The present technology is more flexible in terms of resource management.

For example, it is assumed that frequencies are used as follows.

FIG. 3 is a view showing an example of FAs in a multiband communication scheme.

In FIG. 3, FA0 to FA7 may be managed by RF0 to RF7. In addition, in the example of FIG. 3, it is assumed that FA0, FA2, FA3, FA6 and FA7 are already assigned to the existing specific communication services. It is assumed that available RF1 (FA1), RF4 (FA4) and RF5 (FA5) may be efficiently managed by one MAC (MAC #5). Since RF carriers configuring one MAC may be contiguous to each other as described above, it is possible to more efficiently manage frequency resources. However, as described above, the number of MACs for managing a plurality of RF carriers may be 2 or more.

If CQIs are transmitted in a communication system using a plurality of carriers and a plurality of legacy system bands, an increase in overhead due to the transmission of the CQIs is expected. A detailed method for transmitting the CQIs in the system using the plurality of carriers is not established. Therefore, there is a need to define a method for efficiently transmitting CQIs.

### SUMMARY OF THE INVENTION

Accordingly, the present invention is directed to a method for transmitting Channel Quality Indicators CQIs that substantially obviates one or more problems due to limitations and disadvantages of the related art.

An object of the present invention is to provide a method for efficiently transmitting CQIs in a system using a plurality of carriers.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for transmitting Channel Quality Indicators (CQIs) by a User Equipment (UE) in a communication system using a plurality of legacy system bands includes receiving a signal through the plurality of legacy system bands, and transmitting the CQIs of the plurality of legacy system bands using the same CQI transmission mode according to the legacy system bands. In this case, all the CQIs of the legacy system bands are transmitted if the CQIs of the legacy system bands are transmitted through an uplink shared channel, and the CQIs of the legacy system bands are sequentially transmitted in the unit of a predetermined number of CQIs if the CQIs of the legacy system bands are transmitted through an uplink control channel.

In another aspect of the present invention, a method for transmitting Channel Quality Indicators (CQIs) by a User Equipment (UE) in a communication system using a plurality of legacy system bands includes receiving a signal through the plurality of legacy system bands, and transmitting the CQIs of a specific number of preferred legacy system bands out of the plurality of legacy system bands. In this case, all the CQIs of the specific number of legacy system bands are transmitted if the CQIs of the specific number of legacy system bands are transmitted through an uplink shared channel, and the CQIs of the specific number of legacy system bands are sequentially transmitted in units of a predetermined number of CQIs if the CQIs of the specific number of legacy system bands are transmitted through an uplink control channel and the capacity of the uplink control channel is not sufficient for transmission of all the CQIs of the specific number of legacy system bands.

The method may further include receiving a control signal requesting the transmission of the CQIs, and the CQIs may be transmitted through the uplink shared channel when the CQIs are transmitted after receiving the control signal.

In a transmission mode, in which the transmission of wideband CQIs is requested, out of CQI transmission modes using the uplink shared channel or the uplink control channel, the CQIs of the legacy system bands may be used as the wideband CQIs.

The method for selecting the specific number of preferred legacy system bands and transmitting the CQIs may further include transmitting information about the specific number of preferred legacy system bands. In this case, the information about the selected legacy system bands may be transmitted in a bitmap format or the indexes of the legacy system bands may be transmitted.

The method for selecting the specific number of preferred legacy system bands and transmitting the CQIs may further include transmitting the CQIs of the legacy system bands, which are not selected as the specific number of preferred legacy system bands out of the plurality of legacy system bands, with a predetermined period in the form of wideband CQIs.

According to the method for transmitting the CQIs of the embodiments of the present invention, it is possible to improve system performance by suppressing the performance deterioration of a scheduler while minimizing overhead in a system using a plurality of legacy system bands.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a conceptual diagram of the generation and transmission of CQIs;

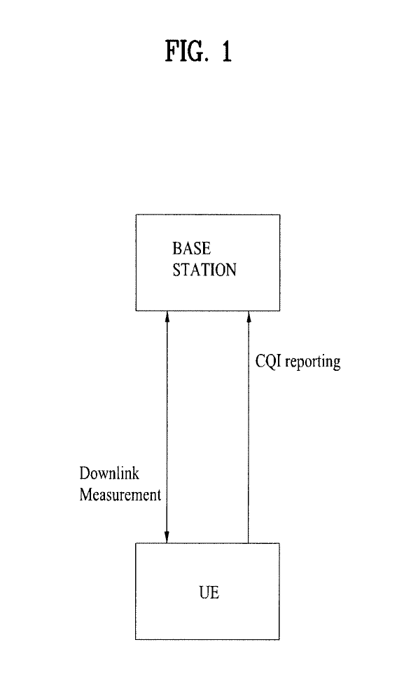

FIGS. 2(a) and 2(b) are conceptual diagrams explaining the multiband RF-based signal transmission and reception methods of a transmitter and a receiver;

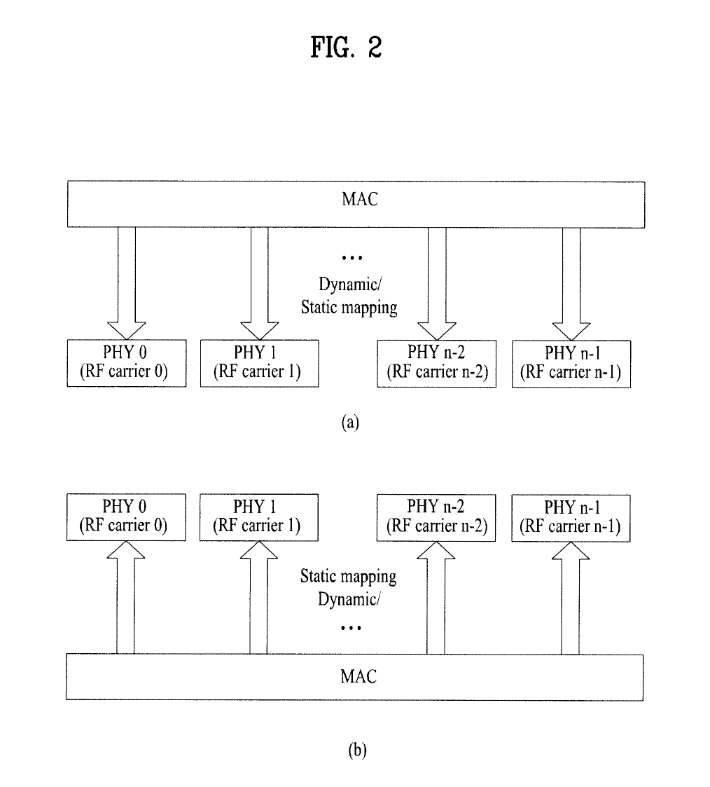

FIG. 3 is a view showing an example of FAs in a multiband communication scheme;

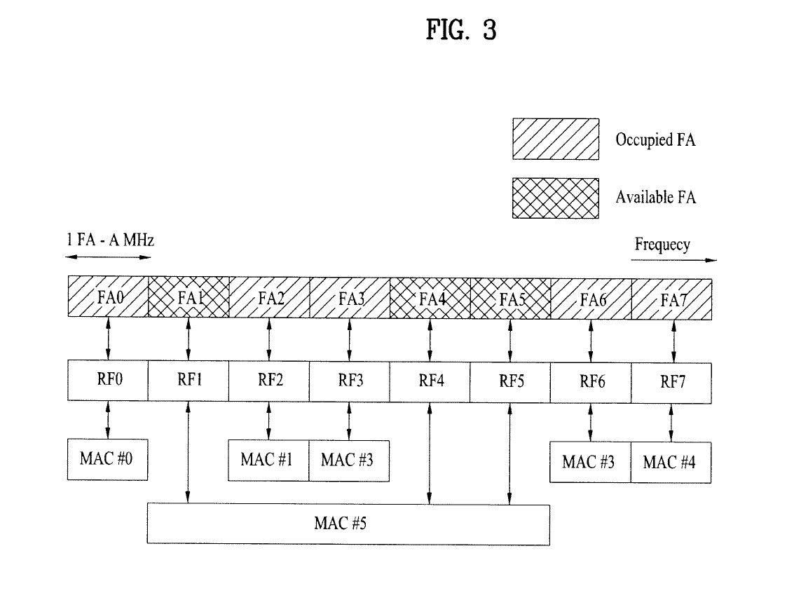

FIG. 4 is a view showing an example in which a wideband system is configured using five carriers; and

FIG. 5 is a view showing schemes for selecting CQI subbands in a frequency domain and generating CQIs.

### DETAILED DESCRIPTION OF THE INVENTION

Hereinafter, the preferred embodiments of the present invention will be described with reference to the accompanying drawings. It is to be understood that the detailed description which will be disclosed along with the accompanying drawings is intended to describe the exemplary embodiments of the present invention, and is not intended to describe a unique embodiment which the present invention can be carried out.

Hereinafter, the detailed description includes detailed matters to provide full understanding of the present invention. However, it will be apparent to those skilled in the art that the present invention can be carried out without the detailed matters. In some instances, well-known structures and devices are omitted in order to avoid obscuring the concepts of the present invention and the important functions of the structures and devices are shown in block diagram form. The same reference numbers will be used throughout the drawings to refer to the same or like parts.

As described above, in one embodiment of the present invention, a method for efficiently generating and transmitting Channel Quality Indicators (CQIs) in a system for transmitting a signal using a plurality of carriers is suggested. In the system for transmitting the signal using the plurality of carriers, an independent control signal may be transmitted through each of the carriers.

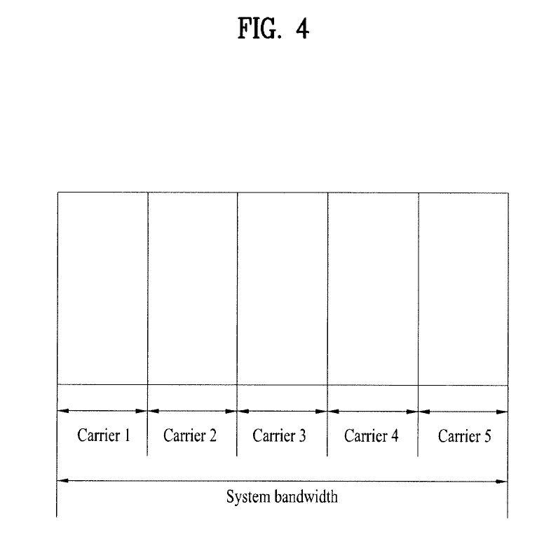

FIG. 4 is a view showing an example in which a wideband system is configured using five carriers.

If it is assumed that a signal within a 20-MHz band is transmitted using one carrier in FIG. 4, a signal within a 100-MHz band may be transmitted using five carriers and independent control signals may be transmitted every 20 MHz. Such a system may be implemented by simply expanding a control channel designed for a 20-MHz system. However, if CQI transmission is considered, CQI/Precoding Matrix Information (PMI)/Rank Information (RI) should be independently transmitted every 20 MHz. Therefore, the amount of control information is increased in proportion to the number of carriers used. In order to transmit the CQI/PMI/RI, many resources should be assigned. Accordingly, it is difficult to efficiently use system resources.

In order to efficiently support a scheduling operation, channel information of bands corresponding to all carriers needs to be reported. The following description is applicable to both downlink and uplink, but a method for transmitting CQIs for downlink data transmission will be described by way of example.

First, in one embodiment of the present invention, a method for transmitting the channel information of all carriers is suggested. In a system using N carriers, CQIs corresponding to the bands of the carriers may be transmitted through an uplink shared channel or an uplink control channel. In a 3rd Generation Partnership Project (3GPP) system, CQIs may be transmitted through a Physical Uplink Shared Channel (PUSCH) or a Physical Uplink Control Channel (PUCCH).

In the present embodiment, it is assumed that the number of methods for generating the CQIs used in the system is only one and the method is applied to all the carriers. The method for generating the CQIs may be differently defined according to the kinds of channel for transmitting the CQIs, and various CQI transmission modes may be present even in channels.

Hereinafter, various methods available for the generation and transmission of CQIs will be described.

As the amount of transmission channels is increased, the following method is available as the generating method for reducing the information amount of the CQI in order to reduce control overhead.

First, a method for changing a channel information transmission unit is available. For example, a method for grouping several subcarriers, through which channel information is transmitted in an Orthogonal Frequency Division Multiplexing (OFDM) scheme, into one subcarrier group and transmitting the channel information in the unit of groups is available. That is, in the OFDM scheme using 600 subcarriers, if 12 subcarriers are grouped into one subcarrier group, a total of 50 subcarrier groups is formed. Therefore, the amount of actually transmitted channel information is reduced from 600 to 50.

In the following description, if a frequency band is divided by an integral number of subcarriers as in the OFDM scheme, the basic unit of a method for grouping one or a plurality of subcarriers into one group and reporting CQIs in units of subcarrier groups is defined as a CQI subcarrier group or a CQI subband. Meanwhile, if a frequency band is not divided by subcarriers, the overall frequency band is divided into a plurality of frequency subbands and CQIs are generated based on the divided frequency subbands. Each of the frequency subbands divided for the generation of the CQIs is a CQI subband.

Second, a method for compressing channel information and generating CQIs is available. For example, a method for compressing the channel information of each of subcarriers using a predetermined compression method and transmitting the channel information in an OFDM scheme is available. Methods such as Discrete Cosine Transform (DCT) may be used as the predetermined compression method.

Third, a method for selecting frequency bands for generating channel information and generating CQIs is available. For example, there is a best-M method for selecting and transmitting best M subcarriers or subcarrier groups but not transmitting channel information of all subcarriers in the OFDM scheme.

A portion, which is actually transmitted when selecting the frequency bands and transmitting the CQIs, may be divided into two portions: a CQI value portion and a CQI index portion.

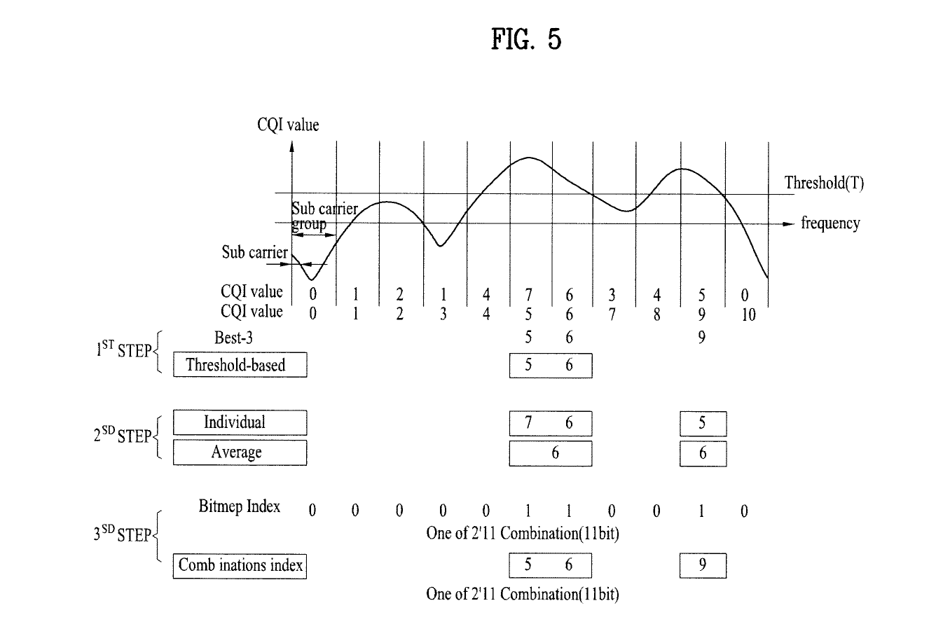

FIG. 5 is a view showing schemes for selecting CQI subbands in a frequency domain and generating CQIs.

A frequency-band-selected CQI method is largely divided into three steps: a first step of selecting frequency bands for generating CQIs, that is, CQI subbands, a second step of manipulating, generating and transmitting CQI values of the selected frequency bands, and a third step of transmitting the indexes of the selected frequency bands, that is, the CQI subbands.

In FIG. 5, examples of the method for selecting the CQI subbands include a Best-M method and a Threshold-based method. In the Best-M method, M CQI subbands with best channel statuses are selected. In the example of FIG. 5, CQI subbands having indexes 5, 6 and 9 with best channel statuses are selected using a Best-3 method. In the threshold-based method, CQI subbands with channel statuses higher than a predetermined threshold are selected. In this example, the CQI subbands having indexes 5 and 6 with channel statuses higher than the threshold are selected.

Examples of the method for generating and transmitting the CQI values include an individual transmission method and an average transmission method. The individual transmission method is a method for transmitting all the CQI values of the CQI subbands selected in the first step. Accordingly, in the individual method, if the number of selected CQI subbands is increased, the number of CQI values to be transmitted is increased. Meanwhile, in the average transmission method, the average of the CQI values of the selected CQI subbands is transmitted. Accordingly, the average transmission method is advantageous in that the number of CQI values to be transmitted is one regardless of the number of selected CQI subbands, but is disadvantageous in that the average of the several CQI subbands is transmitted and thus accuracy is reduced. In the average transmission method, the average may be an arithmetic average or an average considering channel capacity.

Examples of the method for the indexes of the CQI subbands includes a bitmap index method and a combinatorial index method. The bitmap index method refers to a method for assigning one bit to each of all the CQI subbands and indicating which CQI subband is used, by setting the bit to 1 if a CQI subband is used and setting the bit to 0 if a CQI subband is not used. The bitmap index method requires the number of bits corresponding to the total number of CQI subbands, but a constant number of bits may be used regardless of how many CQI subbands are used.

Meanwhile, the combinatorial index method refers to a method for determining how many CQI subbands are used and mapping combinations corresponding to the number of used CQI subbands out of all the CQI subbands to indexes. In more detail, if a total of N CQI subbands is present and M CQI subbands out of N CQIs are used, the number of possible combinations is expressed as follows.

$${}_{N}^{}{C}{}_{M}^{} = \frac{N !}{( N - M ) ! M !} \qquad Equation 1$$

The number of bits indicating the number of cases in Equation 1 may be determined as follows.

$$⌈ {log}_{2} ( {}_{N}^{}{C}{}_{M}^{} ) ⌉ = ⌈ {log}_{2} ( \frac{N !}{( N - M ) ! M !} ) ⌉ \qquad Equation 2$$

In the example of FIG. 5, since three CQI subbands are selected from a total of 11 CQI subbands, the number of cases is 165 (=₁₁C₃) and the number of bits for indicating 165 is 8 bits (2⁷≦₁₁C₃≦2⁸).

Meanwhile, a transmission mode available for CQI transmission will be described in detail as follows.

TABLE 1

| | Periodic CQI | Non-periodic CQI |
|---|---|---|
| Scheduling scheme | transmission | transmission |
| Frequency unselected | PUCCH | — |
| scheme | | |
| Frequency selected | PUCCH | PUSCH |
| scheme | | |

As shown in Table 1, the CQIs may be transmitted using a PUCCH with a period determined by an upper layer or may be non-periodically transmitted using a PUSCH according to the request of a scheduler. The CQIs are transmitted using the PUSCH only in the frequency selected scheme.

Hereinafter, a method for transmitting CQIs according to a request for CQI transmission and a method for periodically transmitting CQIs will be described.

1) Transmission of CQI/PMI/RI Using PUSCH After Receiving CQI Transmission Request Control Signal

In this case, a control signal for requesting CQI transmission is received. Table 2 shows a mode when a CQI/PMI/RI is transmitted through a PUSCH.

TABLE 2

| | | PMI feedback type | | |
|---|---|---|---|---|
| | | PMI non- | Single | Multiple |
| | | transmission | PMI | PMIs |
| PUSCH CQI | Wideband | | | Mode 1-2 |
| feedback type | (wideband CQI) | | | |
| | UE selected | Mode 2-0 | | Mode 2-2 |
| | (subband CQI) | | | |
| | Higher layer- | Mode 3-0 | Mode 3-1 | |
| | configured | | | |
| | (subband CQI) | | | |

The transmission mode of Table 2 is selected in a higher layer, and the CQI/PMI/RI is transmitted through the same PUSCH subframe.

Hereinafter, transmission modes will be described.

First, in “Mode 1-2”, a preceding matrix is selected on the assumption that data is transmitted only through a subband corresponding thereto. A User Equipment (UE) generates CQIs based on the selected preceding matrix in a band (set S) specified by the upper layer or a system band. The UE transmits the CQIs and PMI values of subbands. At this time, the size of each of the subbands may be changed according to the size of the system band.

Next, in “Mode 2-0”, the UE selects M preferred subbands with respect to the band (set S) specified by the upper layer or the system band. The UE generates one CQI value on the assumption that data is transmitted in M selected subbands. The UE further generates one CQI (wideband CQI) value with respect to the set S or the system band. If a plurality of codewords is present in the M selected subbands, the CQI values of the codewords are defined by a differential mode. At this time, values obtained by subtracting a wideband CQI index from indexes corresponding to the CQI values of the selected M subbands are available as the delta CQIs. The UE transmits information about the locations of the M selected subbands, one CQI value of the M selected subbands, and the CQI values generated in the set S or the overall band. At this time, the size and the M value of the subband may be changed according to the size of the system band.

Next, in “Mode 2-2”, the UE simultaneously selects M preferred subbands and a single preceding matrix of the M preferred subbands on the assumption that data is transmitted through the M preferred subbands. The CQI value of the M preferred subbands is defined per codeword. The UE further generates a wideband CQI value with respect to the set S or the system band. In addition, the UE transmits information about the locations of the M selected subbands, one CQI value of the M selected subbands, a single precoding matrix index of the M preferred subbands, and a wideband CQI value. At this time, the size and the M value of the subband may be changed according to the size of the system band.

In addition, in “Mode 3-0”, the UE generates a wideband CQI value. The UE generates the CQI value of each subband on the assumption that data is transmitted through each subband. At this time, even if RI>1, the CQI value indicates only the CQI value of a first codeword.

Finally, in “Mode 3-1”, a single preceding matrix is generated with respect to the system band or the set S. The UE generates the subband CQI per codeword based on the generated single preceding matrix with respected to each subband. In addition, the UE generates a wideband CQI based on the single preceding matrix. The CQI value of each subband is represented by a differential format. At this time, the size of the subband may be changed according to the size of the system band.

2) Periodic Transmission of CQI/PMI/RI Through PUCCH

In this case, CQI information is periodically transmitted through a PUCCH. When a control signal requesting transmission of user data is received, CQIs may be transmitted through a PUCCH. Even when the CQIs are transmitted through the PUSCH, in the contents of CQI/PMI/RI, the CQIs are generated and transmitted by one of the transmission modes defined in Table 3.

TABLE 3

PMI feedback type

| | | PMI non- | Single |
|---|---|---|---|
| | | transmission | PMI |
| PUCCH CQI | Wideband | Mode 1-0 | Mode 1-1 |
| feedback type | (wideband CQI) | | |
| | UE selected | Mode 2-0 | Mode 2-1 |
| | (subband CQI) | | |

In Table 3, in Mode 2-0 and Mode 2-1, a Bandwidth Part (BP) is a set of subbands continuously located in a frequency domain and may cover both the system band and the set S. The size of each subband, the size of the BP and the number of BPs may be changed according to the size of the system band. The CQIs are transmitted in the frequency domain in ascending order according to the BPs so as to cover the system band or the set S.

In a CQI transmission mode, four transmission types are present according to transmission combinations of the CQI/PMI/RI as follows.

(1) Type 1: The subband CQIs of Mode 2-0 and Mode 2-1 are transmitted.

(2) Type 2: The wideband CQI and the PMI are transmitted.

(3) Type 3: The RI is transmitted.

(4) Type 4: The wideband CQI is transmitted.

The RI and the wideband CQI/PMI are transmitted through subframes having different periods and offsets. If the RI and the wideband CQI/PMI should be transmitted through the same subframe, the CQI/PMI is not transmitted.

In the transmission mode, the transmission period of the wideband CQI/PMI and the subband CQI is P and has the following features.

The wideband CQI/PMI has a period of H*P. At this time, H=J*K+1, J denotes the number of BPs, and K is the total number of cycles of the BP. That is, the wideband CQI/PMI is transmitted at {0, H, 2H, . . . }. The subband CQI is transmitted at a J*K time point other than a time point when the wideband CQI/PIM is transmitted.

The transmission period of the RI is M times the wideband CQI/PMI period and has the following features.

The offset of the RI and the wideband CQI/PMI is 0. If the RI and the wideband CQI/PMI are transmitted through the same subframe, the wideband CQI/PMI is not transmitted. All the parameters P, H, K and 0 are set by the upper layer and are signaled.

The transmission modes shown in Table 3 will now be described.

First, if the RI is transmitted in “Mode 1-0”, the RI is generated with respect to the system band or the set S and is transmitted through the type 3 report. If the CQI is transmitted, the wideband CQI is transmitted.

Next, if the RI is transmitted in “Mode 1-1”, the RI is generated with respect to the system band or the set S and is transmitted through the type 3 report. If the CQI/PMI is transmitted, a single preceding matrix is selected based on latest RI. The CQI/PMI is transmitted through the type 2 report configured by the wideband CQI, the single precoding matrix and the delta wideband CQI.

Next, if the RI is transmitted in “Mode 2-0”, the RI is generated with respect to the system band or the set S and is transmitted through the type 3 report. If the wideband CQI is transmitted, the wideband CQI is generated based on the latest RI, and is transmitted through the type 4 report. If the CQI of the selected subband is transmitted, the UE selects a most preferred subband with respect to J BPs configured by N subbands and transmits the subband CQI through the type 1 report. The type 1 report may require one or more subframes according to BPs.

Finally, if the RI is transmitted in “Mode 2-1”, the RI is generated with respect to the system band or the set S and is transmitted through the type 3 report. If the wideband CQI is transmitted, the wideband CQI is generated and is transmitted through the type 4 report, based on the latest RI. If the CQI of the selected subbands is transmitted, the UE generates a single CQI value of subbands selected in BPs based on a latest PMI/RI and a CQI difference of a codeword on the assumption that the single precoding matrix is used in the latest RI and the selected subbands if the RI is greater than 1, and transmits them using the type 1 report, with respect to J BPs configured by Nj subbands.

The CQI transmission mode and type may be differently indicated according to systems, and the transmission mode may be represented by another term indicating the same/similar transmission mode.

Among various CQI transmission methods, in a CQI transmission method used in the present embodiment, CQIs of all carrier bands are transmitted using the same transmission method with respect to carrier bands. For example, if a CQI is generated in a first carrier using Mode 1-2 out of the CQI transmission modes for PUSCH, it is assumed that Mode 1-2 out of the CQI transmission modes for PUSCH is used even in all the other carriers. The CQI generating method may be differently defined in a method for transmitting CQIs after receiving a request for CQI transmission and a method for periodically transmitting CQIs.

In the following description, for convenience of description, if a CQI corresponding to a J^{th} carrier is CQIⱼ, the CQIs of the system corresponding to N carriers are denoted by {CQI₁, . . . CQI_{N}}.

First, the method for transmitting the CQIs using the PUSCH after receiving the CQI transmission request control signal will be described.

In the present embodiment, CQIs corresponding to carriers are generated and combined using a specific CQI generating method selected from Mode 1-2, Mode 2-0, Mode 2-2, Mode 3-0 and Mode 3-1, all of which are the CQI transmission modes using the PUSCH, and all the CQIs of the system corresponding to all the carriers are transmitted. In this case, the wideband CQI/PMI is a CQI/PMI value corresponding to a specific carrier band. RI may be a value corresponding to a specific carrier band or a value corresponding to all the carrier bands.

Next, the method for periodically transmitting the CQIs using the PUCCH will be described.

In the present embodiment, CQIs corresponding to carriers are generated and combined using a specific CQI generating method selected from Mode 1-0, Mode 1-1, Mode 2-0 and Mode 2-1, all of which are CQI transmission modes using the PUCCH, and the CQIs of the system corresponding to all the carriers are transmitted. If the CQIs are transmitted using the PUCCH, since the amount of CQIs transmitted at a transmission time point is restricted, all the CQIs may not be transmitted once. Accordingly, in the present embodiment, the CQIs of the carriers may be set to be sequentially transmitted. That is, with respect to all the CQIs {CQI₁, . . . , CQI_{N}}, the CQIs may be sequentially transmitted from CQI₁ at the respective transmission time points. At this time, the transmission of CQIⱼ (j=1, . . . , N) may be performed according to the transmission modes Mode 1-0, Mode 1-1, Mode 2-0 and Mode 2-1.

Meanwhile, in another embodiment of the present invention, a method for selecting a specific preferred carrier band from a plurality of carrier bands and transmitting CQIs is suggested.

That is, in a system using N carriers, it is preferable that CQIs corresponding to all the carrier bands be secured for scheduling. However, in order to transmit the CQIs, resources should be assigned in proportion to the number of carriers. In order to reduce the resources, when some preferred carrier bands are selected and the CQIs corresponding to the selected carrier bands are transmitted, resources for transmitting a control signal may be efficiently used. That is, the transmission of information about L preferred carriers {CQI_{b1}, . . . , CQI_{bL}} out of all CQIs {CQI₁, . . . , CQI_{N}} is suggested. At this time, it is assumed that N is equal to or greater than bL.

Meanwhile, even in the method for transmitting the CQI according to the present embodiment, the CQI transmission method is defined as follows, depending on whether or not the CQIs are transmitted after receiving the CQI transmission request control signal.

First, a method for transmitting CQIs using a PUSCH after receiving a CQI transmission request control signal will be described. All the CQIs of the L selected carrier bands, that is, {CQI_{b1}, . . . , CQI_{bL}} are transmitted at a transmission time point through the PUSCH. In this case, the wideband CQI/PMI refers to the CQI/PMI value corresponding to the selected carrier bands.

Meanwhile, the CQIs of the carrier band(s) other than the L selected carrier bands are not basically transmitted, but CQI information of the unselected carrier band may be partially transmitted. At this time, the wideband CQI/PMI value may be transmitted as the partial CQI information.

Meanwhile, RI may be a value corresponding to a specific carrier band or a value corresponding to all the carrier bands. At this time, one of the PUSCH transmission modes Mode 1-2, Mode 2-0, Mode 2-2, Mode 3-0 and Mode 3-1 may be used in the transmission of CQIⱼ (j=b1, . . . , bL).

Next, a method for periodically transmitting CQIs using a PUCCH will be described.

CQIs {CQI_{b1}, . . . , CQI_{bL}} of the L selected carriers are transmitted using the PUCCH. At this time, one of the PUCCH transmission modes Mode 1-0, Mode 1-1, Mode 2-0 and Mode 2-1 may be used in the transmission of CQIⱼ (j=b1, . . . , bL).

Even in the present embodiment, the CQIs of the carrier band(s) other than the L selected carrier bands are not basically transmitted, but CQI information of the unselected carrier band may be partially transmitted. At this time, the wideband CQI/PMI value may be transmitted as the partial CQI information.

If the CQIs are transmitted through the PUCCH, since the amount of CQIs transmitted at a transmission time point is restricted, all information about the CQIs corresponding to the selected carrier bands may not be transmitted at once. If all the CQIs are not transmitted at once, the CQIs are divided and transmitted several times. At this time, the locations of the L carriers which are first selected are not changed but are fixed while all the CQIs are divided and transmitted.

For example, the CQIs corresponding to the selected carriers may be sequentially transmitted. That is, CQIs {CQI_{b1}, . . . , CQI_{bL}} may be sequentially transmitted from CQI_{b1}. In addition, information about the locations of the selected carriers may be further transmitted.

As another example, a method for equally dividing the CQIs corresponding to the selected carriers according to times and transmitting the CQIs may be considered. That is, portions of CQIs {CQI_{b1}, . . . , CQI_{bL}} may be transmitted at different times.

A method for transmitting CQIs according to the embodiments of the present invention is applicable to various next-generation mobile communication systems using a plurality of carrier bands (a plurality of legacy system bands).

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for transmitting Channel Quality Indicators (CQIs) by a User Equipment (UE) in a communication system using a plurality of legacy system bands, the method comprising:
receiving a signal through the plurality of legacy system bands; and
transmitting the CQIs of the plurality of legacy system bands using the same CQI transmission mode according to the legacy system bands,
wherein all the CQIs of the legacy system bands are transmitted if the CQIs of the legacy system bands are transmitted through an uplink shared channel, and the CQIs of the legacy system bands are sequentially transmitted in units of a predetermined number of CQIs if the CQIs of the legacy system bands are transmitted through an uplink control channel.

2. The method according to claim 1, further comprising receiving a control signal for requesting transmission of the CQIs,
wherein the CQIs are transmitted through the uplink shared channel when the CQIs are transmitted after receiving the control signal.

3. The method according to claim 1, wherein, in a transmission mode, in which the transmission of wideband CQIs is requested, out of CQI transmission modes using the uplink shared channel or the uplink control channel, the CQIs of the legacy system bands are used as the wideband CQIs.

4. A method for transmitting Channel Quality Indicators (CQIs) by a User Equipment (UE) in a communication system using a plurality of legacy system bands, the method comprising:
receiving a signal through the plurality of legacy system bands; and
transmitting the CQIs of a specific number of preferred legacy system bands out of the plurality of legacy system bands,
wherein all the CQIs of the specific number of legacy system bands are transmitted if the CQIs of the specific number of legacy system bands are transmitted through an uplink shared channel, and
wherein the CQIs of the specific number of legacy system bands are sequentially transmitted in units of a predetermined number of CQIs if the CQIs of the specific number of legacy system bands are transmitted through an uplink control channel and the capacity of the uplink control channel is not sufficient for transmission of all the CQIs of the specific number of legacy system bands.

5. The method according to claim 4, further comprising transmitting information about the specific number of preferred legacy system bands out of the plurality of legacy system bands directly or in a bitmap format.

6. The method according to claim 4, further comprising transmitting the CQIs of the legacy system bands, which are not selected as the specific number of preferred legacy system bands out of the plurality of legacy system bands, with a predetermined period in the form of wideband CQIs.

7. The method according to claim 4, further comprising receiving a control signal for requesting the transmission of the CQIs,
wherein the CQIs are transmitted through the uplink shared channel when the CQIs are transmitted after receiving the control signal.

8. The method according to claim 6, wherein, in a transmission mode, in which the transmission of wideband CQIs is requested, out of CQI transmission modes using the uplink shared channel or the uplink control channel, the CQIs of the legacy system bands are used as the wideband CQIs.
